(19) United States
(12) Patent Application Publication
(10) Pub. No.: US 2008/0178522 A1
(43) Pub. Date: Jul. 31, 2008

(54) Pour point improvers for vegetable or animal fuel oils

(75) Inventors: Bettina Siggelkow, Frankfurt am Main (DE); Werner Reimann, Frankfurt (DE); Ulrike Neuhaus, Oberhausen (DE); Markus Kupetz, Dinslaken (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant International Ltd.

(21) Appl. No.: 11/980,292

(22) Filed: Oct. 30, 2007

(30) Foreign Application Priority Data
Nov. 22, 2006 (DE) 102006054909.9-44

(51) Int. Cl. C10L 1/00; G01N 1/00

(52) U.S. Cl. 44/307; 73/863.11

(57) ABSTRACT

The invention provides a fuel oil composition comprising a fuel oil of animal or vegetable origin, in which a total of more than 6% by weight of palmitic acid methyl ester and stearic acid methyl ester are present, and, as an additive,
A) at least one copolymer which contains 10-20 mol % of structural units of at least one vinyl ester and 80-90 mol % of structural units of ethylene, and
B) at least one comb polymer containing structural units formed from
B1) at least one olefin as monomer 1, which bears at least one C₈-C₁₈-alkyl radical on the olefinic double bond, and
B2) at least one ethylenically unsaturated dicarboxylic acid as monomer 2, which bears at least one C₈-C₁₆-alkyl radical bonded via an amide and/or imide group,
   in which the parameter Q

$$Q = {\sum }_{i} {w}_{1 i} \cdot {n}_{1 i} + {\sum }_{j} {w}_{2 j} \cdot {n}_{2 j}$$

in which
w₁ is the molar proportion of the individual chain lengths n₁ in the alkyl radicals of monomer 1,
w₂ is the molar proportion of the individual chain lengths n₂ in the alkyl radicals of the amide and/or imide groups of monomer 2,
n₁ are the individual chain lengths in the alkyl radicals of monomer 1,
n₂ are the individual chain lengths in the alkyl radicals of the amide and/or imide groups of monomer 2,
i is the serial variable for the chain lengths in the alkyl radicals of monomer 1, and
j is the serial variable for the chain lengths in the alkyl radicals of the amide and/or imide groups of monomer 2,
   assumes values of from 23 to 27.

The present invention relates to an additive, to its use as a pour point improver for vegetable or animal fuel oils and to correspondingly additized fuel oils.

In view of decreasing world crude oil reserves and the discussion about the environmentally damaging consequences of the use of fossil and mineral fuels, there is increasing interest in alternative energy sources based on renewable raw materials. These include in particular natural oils and fats of vegetable or animal origin. These are generally triglycerides of fatty acids having from 10 to 24 carbon atoms and a calorific value comparable to conventional fuels, but are at the same time regarded as being less harmful to the environment. Biofuels, i.e. fuels derived from animal or vegetable material, are obtained from renewable sources and, when they are combusted, therefore generate only as much CO₂ as had previously been converted to biomass. It has been reported that less carbon dioxide is formed in the course of combustion than by the equivalent amount of crude oil distillate fuel, for example diesel fuel, and that very little sulfur dioxide is formed. In addition, they are biodegradable.

Oils obtained from animal or vegetable material are mainly metabolism products which include triglycerides of monocarboxylic acids, and generally correspond to the formula

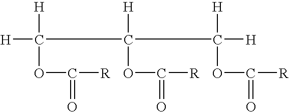

where R is an aliphatic radical which has from 10 to 25 carbon atoms and may be saturated or unsaturated.

In general, such oils contain glycerides from a series of acids whose number and type vary with the source of the oil, and they may additionally contain phosphoglycerides. Such oils can be obtained by processes known from the prior art.

As a consequence of the sometimes unsatisfactory physical properties of the triglycerides, the industry has applied itself to converting the naturally occurring triglycerides to fatty acid esters of lower alcohols such as methanol or ethanol.

Triglycerides and fatty acid esters of lower monohydric alcohols have the property of crystallizing at low temperatures and of forming gel structures, which limits or entirely prevents the ability of the oil to flow. The lowest temperature at which the oil is still free-flowing is known as the pour point. With increasing oil temperature, the capability of the oil to flow is also reduced, and hence the possibility of conveying or of pumping the oil through pipelines, or of storing it in liquid form without heating in tanks, containers, etc.

This phenomenon is known for mineral diesel and heating oil, and also for crude oils and residue oils. The additives used in these oils to reduce the pour points do not exhibit any pour point reduction in fatty acid esters (FAMEs), which are used as biofuels.

The cause of this is the high homogeneity of these oils compared to mineral oil middle distillates, and the polarity of the methyl esters. These lead to altered crystallization behavior as a mixture of different paraffins, as exist in fuels based on mineral oils. For example, soybean oil methyl ester (SME) has a pour point (PP) of −3° C.-+3° C. With the prior art additives, it has not been possible to date to reliably adjust the pour point of biodiesel (FAME) to a PP of −25° C. required in practical terms for use as winter diesel, or else of −30° C. and lower for specialty applications. This problem is aggravated when oils which comprise relatively large amounts of saturated fatty acid esters are used, as are present, for example, in sunflower oil methyl ester, used oil methyl ester or palm oil methyl ester.

Some of the cold flow improvers for biodiesel known in the prior art achieve a reduction of the CFPP to the required specification values. However, they are not capable of reducing the pour point of methyl esters derived from soybean oil, palm oil, sunflower oil, used oil, etc.

EP-A-0 665 873 discloses a fuel oil composition which includes a biofuel, a fuel oil based on crude oil and an additive which comprises (a) an oil-soluble ethylene copolymer or (b) a comb polymer or (c) a polar nitrogen compound or (d) a compound in which at least one substantially linear alkyl group having from 10 to 30 carbon atoms is bonded to a nonpolymeric organic radical, in order to provide at least one linear chain of atoms which includes the carbon atoms of the alkyl groups and one or more nonterminal oxygen atoms, or (e) one or more of components (a), (b), (c) and (d).

EP-A-0 629 231 discloses a composition which comprises a relatively large proportion of oil which consists substantially of alkyl esters of fatty acids which are derived from vegetable or animal oils or both, mixed with a small proportion of mineral oil cold flow improvers, which comprises one or more of the following:
(I) comb polymer, the copolymer (which may be esterified) of maleic anhydride or fumaric acid and another ethylenically unsaturated monomer, or polymer or copolymer of α-olefin, or fumarate or itaconate polymer or copolymer,
(II) polyoxyalkylene ester, ester/ether or a mixture thereof,
(III) ethylene/unsaturated ester copolymer,
(IV) polar, organic, nitrogen-containing paraffin crystal growth inhibitor,
(V) hydrocarbon polymer,
(VI) sulfur-carboxyl compounds and
(VII) aromatic pour point depressant modified with hydrocarbon radicals,
   with the proviso that the composition does not comprise any mixtures of polymeric esters or copolymers of esters of acrylic and/or methacrylic acid which are derived from alcohols having from 1 to 22 carbon atoms.

EP-A-0 543 356 discloses a process for preparing compositions having improved low temperature performance for use as fuels or lubricants, starting from the esters of naturally occurring long-chain fatty acids with monohydric C₁-C₆-alcohols (FAE), which comprises
a) adding PPD additives (pour point depressants) known per se and used for improving the low temperature performance of mineral oils in amounts of from 0.0001 to 10% by weight, based on the long-chain fatty acid esters FAE and
b) cooling the nonadditized long-chain fatty acid esters FAE to a temperature below the cold filter plugging point and
c) removing the resulting precipitates (FAN).

DE-A-40 40 317 discloses mixtures of fatty acid lower alkyl esters having improved cold stability comprising
a) from 58 to 95% by weight of at least one ester within the iodine number range from 50 to 150 and being derived from fatty acids having from 12 to 22 carbon atoms and lower aliphatic alcohols having from 1 to 4 carbon atoms,
b) from 4 to 40% by weight of at least one ester of fatty acids having from 6 to 14 carbon atoms and lower aliphatic alcohols having from 1 to 4 carbon atoms and
c) from 0.1 to 2% by weight of at least one polymeric ester.

EP-A-0 153 176 discloses the use of polymers based on unsaturated dialkyl C₄-C₈-dicarboxylates having an average alkyl chain length of from 12 to 14 as cold flow improvers for certain crude oil distillate fuel oils. Mentioned as suitable comonomers are unsaturated esters, in particular vinyl acetate, but also α-olefins.

EP-A-0 153 177 discloses an additive concentrate which comprises a combination of
I) a copolymer having at least 25% by weight of an n-alkyl ester of a monoethylenically unsaturated C₄-C₈ mono- or dicarboxylic acid, the average number of carbon atoms in the n-alkyl radicals being 12-14, and another unsaturated ester or an olefin, with
II) another low temperature flow improver for distillate fuel oils.

EP-A-1 491 614 discloses oils of vegetable or animal origin and their blends with crude oil distillate fuel oils, which comprise an ethylene-vinyl ester copolymer which contains at least 17 mol % of vinyl ester and has a degree of branching of 5 or more alkyl branches per 100 methylene groups to improve their low temperature properties.

With the known additives, it is often impossible to adjust fatty acid esters, especially those which comprise a total of more than 6% by weight of palmitic acid methyl ester and stearic acid methyl ester, to a pour point of −25° C. or −30° C. necessary for problem-free handling. Moreover, especially oils having a high content of palmitic acid methyl ester and stearic acid methyl ester exhibit a strong tendency to sediment in the course of storage at low temperatures. It is known from practice that sedimentations of the additized fatty acid esters which occur in laboratory experiments under cold conditions, in spite of pumpability and achievement of CFPP, can lead to filter blockages in the engine, and the fuel is therefore unsuitable for traffic use. The sedimentation leads to the known pour point measuring instruments for laboratories, for example the known Herzog MC 850, HCP 852 and MP 852 units, measuring the pour point until the entire sample is solid. In the case of some additives, this allows a low pour point to be simulated even through the sample already has a substantial proportion of solid sediment. It was accordingly an object of the invention to provide fuel oils which exhibit lower sedimentation tendency. It was a further object to reduce the inaccuracy of the pour point measurement owing to the sedimentation.

It was a further object to provide additives for improving the handling of fatty acid esters which are derived, for example, from used oil, sunflower oil, soybean oil and/or palm oil and which contain at least 6% by weight of palmitic acid methyl ester and stearic acid methyl ester, and a flowability of −25° C. and lower should be established. The flowability should be determined by the “modified pour point” method described below. The additized oil sample should thus, after storage at −25° C. over several hours, clearly pass the test.

It has now been found that, surprisingly, an additive comprising ethylene copolymers and comb polymers is an excellent flow improver for such fatty acid esters.

The invention provides a fuel oil composition comprising a fuel oil of animal or vegetable origin, in which a total of more than 6% by weight of palmitic acid methyl ester and stearic acid methyl ester are present, and, as an additive,
A) at least one copolymer which contains 10-20 mol % of structural units of at least one vinyl ester and 80-90 mol % of structural units of ethylene, and
B) at least one comb polymer containing structural units formed from
B1) at least one olefin as monomer 1, which bears at least one C₈-C₁₈-alkyl radical on the olefinic double bond, and
B2) at least one ethylenically unsaturated dicarboxylic acid as monomer 2, which bears at least one C₈-C₁₆-alkyl radical bonded via an amide and/or imide group,
   in which the parameter Q

$$Q = {\sum }_{i} {w}_{1 i} \cdot {n}_{1 i} + {\sum }_{j} {w}_{2 j} \cdot {n}_{2 j}$$

in which
w₁ is the molar proportion of the individual chain lengths n₁ in the alkyl radicals of monomer 1,
w₂ is the molar proportion of the individual chain lengths n₂ in the alkyl radicals of the amide and/or imide groups of monomer 2,
n₁ are the individual chain lengths in the alkyl radicals of monomer 1,
n₂ are the individual chain lengths in the alkyl radicals of the amide and/or imide groups of monomer 2,
i is the serial variable for the chain lengths in the alkyl radicals of monomer 1, and
j is the serial variable for the chain lengths in the alkyl radicals of the amide and/or imide groups of monomer 2,
   assumes values of from 23 to 27.

The invention further provides for the use of the above-defined additive for improving the pour point properties under cold conditions of fuel oils of animal or vegetable origin, in which a total of more than 6% by weight of palmitic acid methyl ester and stearic acid methyl ester are present.

Preference is given to determining the pour point by additizing a sample of the fuel to be examined with flow improver and introducing it into a colorless transparent sample vessel, heating this sample to a test temperature and storing it at this test temperature for at least 24 hours, and then assessing the sample as to whether it has a homogeneous fluid consistency.

The invention further provides a process for improving the pour point properties of fuel oils of animal or vegetable origin which comprise a total of more than 6% by weight of palmitic acid methyl ester and stearic acid methyl ester, by adding the above-defined additive to the fuel oils of animal or vegetable origin.

In order to have available a reliable test for determining the necessary free flow, a new test has been developed, which determines a parameter referred to hereinafter as “modified pour point”. To this end, a sample (usually 50 or 250 ml) of the fuel to be examined is additized with flow improver (the flow improver is introduced) and filled into a colorless transparent sample vessel. Subsequently, this sample is placed in a cold chamber which has already been cooled to the test temperature. The sample is thus, without moving it in the meantime, stored at a previously selected test temperature which is preferably −5° C., −10° C., −15° C., −20° C., −25° C., −30° C., or −35° C. over a particular time, preferably 24 h, 48 h or 72 h. Subsequently, the sample is assessed visually by raising it (without shaking). By gentle tilting to and fro, it is assessed whether the sample has a homogeneous fluid consistency. The test is considered to be passed when the sample is homogeneous in its appearance and its consistency, and is fluid throughout, without sediment formation.

In a preferred embodiment of the invention, Q has values of from 24 to 26.

Chain length of olefins is understood here to mean the chain length of the monomeric olefin minus the two olefinically bonded carbon atoms. In olefins with nonterminal double bonds, for example olefins with a vinylidene moiety, the chain length is equal to the total chain length of the olefin minus the two olefinically bonded carbon atoms.

When the polymers formed from the olefins B1) and the dicarboxamides/imides B2) rather than the monomeric olefins are considered, the chain length is the length of the alkyl radicals which—introduced into the polymer by the olefin—depart from the polymer backbone.

Suitable ethylene copolymers A) are preferably those which contain from 10-20 mol %, preferably from 13 to 18 mol %, of one or more vinyl esters and/or (meth)acrylic esters, and from 80 to 90 mol %, preferably from 82 to 87 mol %, of ethylene. Suitable vinyl esters derive from fatty acids having linear or branched alkyl groups having from 1 to 30 carbon atoms. The preferred ethylene copolymers have a molecular weight Mw of 3000-20 000 g/mol. Their melt viscosity at 140° C. is preferably from 80 to 300 mPas.

Examples of suitable vinyl esters are vinyl acetate, vinyl propionate, vinyl butyrate, vinyl hexanoate, vinyl heptanoate, vinyl octanoate, vinyl laurate and vinyl stearate, and esters of vinyl alcohol based on branched fatty acids, such as vinyl isobutyrate, vinyl pivalate, vinyl 2-ethylhexanoate, vinyl isononanoate, vinyl neononanoate, vinyl neodecanoate and vinyl neoundecanoate. Likewise suitable as comonomers are esters of acrylic acid and methacrylic acid having from 1 to 20 carbon atoms in the alkyl radical, such as methyl (meth)acrylate, ethyl (meth)acrylate, propyl (meth)acrylate, n- and isobutyl (meth)acrylate, hexyl (meth)acrylate, octyl (meth)acrylate, 2-ethylhexyl (meth)acrylate, decyl (meth)acrylate, dodecyl (meth)acrylate, tetradecyl (meth)acrylate, hexadecyl (meth)acrylate, octadecyl (meth)acrylate. Also suitable are mixtures of two, three, four or even more of these comonomers.

Further preferred copolymers contain, in addition to ethylene and from 10 to 20 mol %, preferably from 13 to 18 mol %, of vinyl esters, also from 0.5 to 10 mol % of olefins having from 3 to 10 carbon atoms, for example propene, butene, isobutylene, hexene, 4-methylpentene, octene, diisobutylene and/or norbornene.

The copolymers A preferably have weight-average molecular weights Mw of 3000-20 000 g/mol, measured by means of gel permeation chromatography (GPC) against polystyrene standards in THF. Their degrees of branching determined by means of ¹H NMR spectroscopy are preferably less than 6 CH₃/100 CH₂ groups. The methyl groups stem from the short-chain and long-chain branches, and not from copolymerized comonomers.

The copolymers (A) can be prepared by customary copolymerization processes, for example suspension polymerization, solution polymerization, gas phase polymerization or high pressure bulk polymerization. Preference is given to carrying out the high pressure bulk polymerization at pressures of from 50 to 400 MPa, preferably from 100 to 300 MPa, and temperatures from 100 to 300° C., preferably from 150 to 250° C. In a particularly preferred preparation variant, the polymerization is effected in a multizone reactor in which the temperature difference between the peroxide feeds along the tubular reactor is kept to a minimum, i.e. <50° C., preferably <30° C., in particular <15° C. The temperature maxima in the individual reaction zones preferably differ by less than 30° C., more preferably by less than 20° C. and especially by less than 10° C.

The reaction of the monomers is initiated by free radical-forming initiators (free radical chain initiators). This substance class includes, for example, oxygen, hydroperoxides, peroxides and azo compounds, such as cumene hydroperoxide, t-butyl hydroperoxide, dilauroyl peroxide, dibenzoyl peroxide, bis(2-ethylhexyl) peroxodicarbonate, t-butyl perpivalate, t-butyl permaleate, t-butyl perbenzoate, dicumyl peroxide, t-butyl cumyl peroxide, di(t-butyl) peroxide, 2,2′-azobis(2-methyl-propanonitrile), 2,2′-azobis(2-methylbutyronitrile). The initiators are used individually or as a mixture of two or more substances in amounts of from −0.01 to 20% by weight, preferably from 0.05 to 10% by weight, based on the monomer mixture.

The high-pressure bulk polymerization is carried out in known high-pressure reactors, for example autoclaves or tubular reactors, batchwise or continuously; tubular reactors have been found to be particularly useful. Solvents such as aliphatic and/or aromatic hydrocarbons or hydrocarbon mixtures, benzene or toluene may be present in the reaction mixture. Preference is given to the substantially solvent-free procedure. In a preferred embodiment of the polymerization, the mixture of the monomers, the initiator and, if used, the moderator, is fed to a tubular reactor via the reactor entrance and also via one or more side branches. Preferred moderators are, for example, hydrogen, saturated and unsaturated hydrocarbons, for example propane or propene, aldehydes, for example propionaldehyde, n-butyraldehyde or isobutyraldehyde, ketones, for example acetone, methyl ethyl ketone, methyl isobutyl ketone, cyclohexanone, and alcohols, for example butanol. The comonomers and also the moderators may be metered into the reactor either together with ethylene or else separately via sidestreams. The monomer streams may have different compositions (EP-A-0 271 738 and EP-A-0 922 716).

Examples of suitable co- or terpolymers include:

ethylene-vinyl acetate copolymers having 10-40% by weight of vinyl acetate and 60-90% by weight of ethylene;
the ethylene-vinyl acetate-hexene terpolymers known from DE-A-34 43 475;
the ethylene-vinyl acetate-diisobutylene terpolymers described in EP-A-0 203 554;
the mixture of an ethylene-vinyl acetate-diisobutylene terpolymer and an ethylene/vinyl acetate copolymer known from EP-A-0 254 284;
the mixtures of an ethylene-vinyl acetate copolymer and an ethylene-vinyl acetate-N-vinylpyrrolidone terpolymer known from EP-A-0 405 270;
the ethylene/vinyl acetate/isobutyl vinyl ether terpolymers described in EP-A-0 463 518;
the ethylene/vinyl acetate/vinyl neononanoate or vinyl neodecanoate terpolymers which, apart from ethylene, contain 10-35% by weight of vinyl acetate and 1-25% by weight of the particular neo compound, known from EP-A-0 493 769;
the terpolymers of ethylene, a first vinyl ester having up to 4 carbon atoms and a second vinyl ester which is derived from a branched carboxylic acid having up to 7 carbon atoms or a branched but nontertiary carboxylic acid having from 8 to 15 carbon atoms, described in EP-A-0 778 875;
the terpolymers of ethylene, the vinyl ester of one or more aliphatic C₂- to C₂₀-monocarboxylic acids and 4-methylpentene-1, described in DE-A-196 20 118;
the terpolymers of ethylene, the vinyl ester of one or more aliphatic C₂- to C₂₀-monocarboxylic acids and bicyclo[2.2.1]hept-2-ene, disclosed in DE-A-196 20 119;
the terpolymers of ethylene and at least one olefinically unsaturated comonomer which contains one or more hydroxyl groups, described in EP-A-0 926 168.

Preference is given to using mixtures of identical or different ethylene copolymers. The polymers on which the mixtures are based more preferably differ in at least one characteristic. For example, they may contain different comonomers, different comonomer contents, molecular weights and/or degrees of branching. The mixing ratio of the different ethylene copolymers is preferably between 20:1 and 1:20, preferably from 10:1 to 1:10, in particular from 5:1 to 1:5.

The copolymers B are derived from the amides and imides of ethylenically unsaturated dicarboxylic acids. Preferred dicarboxylic acids are maleic acid, fumaric acid and itaconic acid. Particularly suitable comonomers are monoolefins having from 10 to 20, in particular having from 12 to 18, carbon atoms. These are preferably linear and the double bond is preferably terminal, as, for example, in dodecene, tridecene, tetradecene, pentadecene, hexadecene, heptadecene and octadecene. The molar ratio of dicarboxamide/imide to olefin or olefins in the polymer is preferably in the range from 1:1.5 to 1.5:1, and is especially equimolar.

It is possible for copolymer B also to contain minor amounts of up to 20 mol %, preferably <10 mol %, especially <5 mol %, of further comonomers which are copolymerizable with ethylenically unsaturated dicarboxamides/imides and the olefins mentioned, for example relatively short- and long-chain olefins (below C₁₀ and above C₂₀), allyl polyglycol ethers, C₁-C₃₀-alkyl (meth)acrylates, vinylaromatics or C₁-C₂₀-alkyl vinyl ethers. Equally, minor amounts of poly(isobutylenes) having molecular weights of up to 5000 g/mol are used, preference being given to highly reactive variants having a high proportion of terminal vinylidene groups. These further comonomers are not taken into account in the calculation of the parameter Q which is critical for the effectiveness.

Allyl polyglycol ethers correspond to the general formula

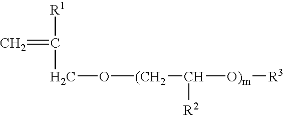

where
R¹ is hydrogen or methyl,
R² is hydrogen or C₁-C₄-alkyl,
m is a number from 1 to 100,
R³ is C₁-C₂₄-alkyl, C₅-C₂₀-cycloalkyl, C₆-C₁₈-aryl or —C(O)—R⁴,
R⁴ is C₁-C₄₀-alkyl, C₅-C₁₀-cycloalkyl or C₆-C₁₈-aryl.

The inventive copolymers B) are prepared preferably at temperatures between 50 and 220° C., in particular from 100 to 190° C. The preferred preparation process is solvent-free bulk polymerization, but it is also possible to carry out the polymerization in the presence of aprotic solvent such as benzene, toluene, xylene or of higher-boiling aromatic, aliphatic or isoaliphatic solvents or solvent mixtures such as kerosene or Solvent Naphtha. Particular preference is given to polymerizing in a small amount of moderating, aliphatic or isoaliphatic solvents. The proportion of solvent in the polymerization mixture is generally between 10 and 90% by weight, preferably between 35 and 60% by weight. In the solution polymerization, the reaction temperature may be adjusted particularly simply by the boiling point of the solvent or by working under reduced or elevated pressure.

The average molecular mass Mw of the inventive copolymers B is generally between 1200 and 200 000 g/mol, in particular between 2000 and 100 000 g/mol, measured by means of gel permeation chromatography (GPC) against polystyrene standards in THF. Inventive copolymers B have to be oil-soluble in doses relevant in practice, i.e. they have to dissolve without residue at 50° C. in the oil to be additized.

The reaction of the monomers is initiated by free radical-forming initiators (free-radical chain starters). This substance class includes, for example, oxygen, hydroperoxides and peroxides, for example cumene hydroperoxide, t-butyl hydroperoxide, dilauroyl peroxide, dibenzoyl peroxide, bis(2-ethylhexyl) peroxodicarbonate, t-butyl perpivalate, t-butyl permaleate, t-butyl perbenzoate, dicumyl peroxide, t-butyl cumyl peroxide, di(t-butyl) peroxide, and also azo compounds, for example 2, 2′-azobis(2-methylpropanonitrile) or 2,2′-azobis(2-methylbutyronitrile). The initiators are used individually or as a mixture of two or more substances in amounts of from 0.01 to 20% by weight, preferably from 0.05 to 10% by weight, based on the monomer mixture.

The copolymers may be prepared either by reacting maleic acid, fumaric acid and/or itaconic acid or their anhydrides with the corresponding amine and subsequently copolymerizing, or by copolymerizing olefin or olefins with at least one unsaturated dicarboxylic acid or derivative thereof, for example itaconic anhydride and/or maleic anhydride and subsequently reacting with amines. Preference is given to carrying out a copolymerization with anhydrides and converting the resulting copolymer to an amide and/or an imide after the preparation.

In both cases, the reaction with amines is effected, for example, by reacting with from 0.8 to 2.5 mol of amine per mole of anhydride, preferably with from 1.0 to 2.0 mol of amine per mole of anhydride, at from 50 to 300° C. When approx. 1 mol of amine is used per mole of anhydride, monoamides are formed preferentially at reaction temperatures of from approx. 50 to 100° C. and additionally bear one carboxyl group per amide group. At higher reaction temperatures of from approx. 100 to 250° C., imides are formed preferentially from primary amines with elimination of water. When larger amounts of amine are used, preferably 2 mol of amine per mole of anhydride, amide-ammonium salts are formed at from approx. 50 to 200° C. and diamides at higher temperatures of, for example, 100-300° C., preferably 120-250° C. The water of reaction may be distilled off by means of an inert gas stream or removed by means of azeotropic distillation in the presence of an organic solvent. To this end, preferably 20-80%, in particular 30-70%, especially 35-55% by weight of at least one organic solvent is used. Here, copolymers (diluted to 50% in solvent) having acid numbers of 30-70 mg KOH/g, preferably of 40-60 mg KOH/g, are regarded as monoamides. Corresponding copolymers having acid numbers of less than 40 mg, especially less than 30 mg KOH/g, are regarded as diamides or imides. Particular preference is given to monoamides and imides.

Suitable amines are primary and secondary amines having one or two C₈-C₁₆-alkyl radicals. They may bear one, two or three amino groups which are bonded via alkylene radicals having two or three carbon atoms. Preference is given to monoamines. In particular, they bear linear alkyl radicals, but may also contain minor amounts, for example up to 30% by weight, preferably up to 20% by weight and especially up to 10% by weight of branched amines (in the 1- or 2-position). Either shorter- or longer-chain amines may be used, but their proportion is preferably below 20 mol % and especially below 10 mol %, for example between 1 and 5 mol %, based on the total amount of the amines used.

Particularly preferred primary amines are octylamine, 2-ethylhexylamine, decylamine, undecylamine, dodecylamine, n-tridecylamine, isotridecylamine, tetradecylamine, pentadecylamine, hexadecylamine and mixtures thereof.

Preferred secondary amines are dioctylamine, dinonylamine, didecylamine, didodecylamine, ditetradecylamine, dihexadecylamine, and also amines having different alkyl chain lengths, for example N-octyl-N-decylamine, N-decyl-N-dodecylamine, N-decyl-N-tetradecylamine, N-decyl-N-hexadecylamine, N-dodecyl-N-tetradecylamine, N-dodecyl-N-hexadecylamine, N-tetradecyl-N-hexadecylamine. Also suitable in accordance with the invention are secondary amines which, in addition to a C₈-C₁₆-alkyl radical, bear shorter side chains having from 1 to 5 carbon atoms, for example methyl or ethyl groups. In the case of secondary amines, it is the average of the alkyl chain lengths of from C₈ to C₁₆ that is taken into account as the alkyl chain length n for the calculation of the parameter Q. Neither shorter nor longer alkyl radicals, where present, are taken into account in the calculation, since they do not contribute to the effectiveness of the additives.

Particularly preferred copolymers B contain monoamides and diamides of primary monoamines as monomer 2.

The use of mixtures of different olefins in the polymerization and mixtures of different amines in the amidation or imidation allows the effectiveness to be further adapted to specific fatty acid ester compositions.

In a preferred embodiment, the additives, as well as constituents A and B, may also comprise polymers and copolymers based on C₁₀-C₂₄-alkyl acrylates or methacrylates (constituent C). These poly(alkyl acrylates) and methacrylates have molecular weights Mw of from 800 to 1 000 000 g/mol, and derive preferably from caprylic alcohol, capric alcohol, undecyl alcohol, lauryl alcohol, myristyl alcohol, cetyl alcohol, palmitoleyl alcohol, stearyl alcohol or mixtures thereof, for example coconut alcohol, palm alcohol, tallow fat alcohol or behenyl alcohol.

In a preferred embodiment, mixtures of different copolymers B are used, the mean of the parameter Q of the mixture components assuming values of from 23 to 27 and preferably values of from 24 to 26.

The mixing ratio of the inventive additive constituents A and B is (in parts by weight) from 20:1 to 1:20, preferably from 10:1 to 1:10, in particular from 5:1 to 1:5. The proportion of component C in the formulations composed of A, B and C may be up to 40% by weight; it is preferably less than 20% by weight, in particular between 1 and 10% by weight, based on the total weight of A, B and C.

The inventive additives are added to oils in amounts of from 0.001 to 5% by weight, preferably from 0.005 to 1% by weight and especially from 0.01 to 0.6% by weight. They may be used as such or else dissolved or dispersed in solvents, for example aliphatic and/or aromatic hydrocarbons or hydrocarbon mixtures, for example toluene, xylene, ethylbenzene, decane, pentadecane, petroleum fractions, kerosene, naphtha, diesel, heating oil, isoparaffins or commercial solvent mixtures such as Solvent Naphtha, ®Hydrosol A 200 N, ®Shellsol A 150 ND, ®Caromax 20 LN, ®Shellsol AB, ®Solvesso 150, ®Solvesso 150 ND, ®Solvesso 200, ®Exxsol, ®Isopar and ®Shellsol D types. They are preferably dissolved in fuel oil of animal or vegetable origin based on fatty acid alkyl esters. The inventive additives preferably comprise 1-80%, especially 10-70%, in particular 25-60%, of solvent.

In a preferred embodiment, the fuel oil, which is frequently also referred to as biodiesel or biofuel, comprises fatty acid alkyl esters composed of fatty acids having from 12 to 24 carbon atoms and alcohols having from 1 to 4 carbon atoms. Typically, a relatively large portion of the fatty acids contains one, two or three double bonds.

Examples of oils which are derived from animal or vegetable material and in which the inventive additive can be used are coriander oil, soybean oil, cottonseed oil, sunflower oil, castor oil, olive oil, peanut oil, maize oil, almond oil, palm kernel oil, coconut oil, mustardseed oil, bovine tallow, bone oil, fish oils, cotton oil and used cooking oils. Further examples include oils which are derived from wheat, jute, sesame, shea tree nut, arachis oil and linseed oil. The fatty acid alkyl esters also referred to as biodiesel can be derived from these oils by processes disclosed by the prior art. Preference is given to soybean oil, which is a mixture of fatty acids partially esterified with glycerol, since it is obtainable in large amounts and is obtainable in a simple manner by extractive pressing of soya seeds. In addition, preference is given to the likewise widely available oils of used oil, palm oil, sunflowers and coconut oil, and also to their mixtures with rapeseed oil.

Particularly suitable biofuels are lower alkyl esters of fatty acids. These include, for example, commercially available mixtures of the ethyl, propyl, butyl and in particular methyl esters of fatty acids having from 14 to 22 carbon atoms, for example of lauric acid, myristic acid, palmitic acid, palmitoleic acid, stearic acid, oleic acid, elaidic acid, petroselic acid, ricinolic acid, elaeostearic acid, linoleic acid, linolenic acid, eicosanoic acid, gadoleic acid, docosanoic acid or erucic acid, each of which preferably has an iodine number of from 50 to 150, in particular from 90 to 125. Mixtures having particularly advantageous properties are those which comprise mainly, i.e. comprise at least 50% by weight of, methyl esters of fatty acids having from 16 to 22 carbon atoms, and 1, 2 or 3 double bonds. The preferred lower alkyl esters of fatty acids are the methyl esters of oleic acid, linoleic acid, linolenic acid and erucic acid.

Commercial mixtures of the type mentioned are obtained, for example, by hydrolyzing and esterifying, or by transesterifying, animal and vegetable fats and oils with lower aliphatic alcohols. Equally suitable as starting materials are used cooking oils. To prepare lower alkyl esters of fatty acids, it is advantageous to start from fats and oils having a high iodine number, for example sunflower oil, rapeseed oil, coriander oil, castor oil, soybean oil, cottonseed oil, peanut oil or bovine tallow. Preference is given to lower alkyl esters of fatty acids based on a novel type of rapeseed oil, more than 80% by weight of whose fatty acid component is derived from unsaturated fatty acids having 18 carbon atoms.

A biofuel is therefore an oil which is obtained from vegetable or animal material or both or a derivative thereof which can be used as a fuel and in particular as a diesel or heating oil. Although many of the above oils can be used as biofuels, preference is given firstly to vegetable oil derivatives, particularly preferred biofuels being alkyl ester derivatives of rapeseed oil, cottonseed oil, soybean oil, sunflower oil, olive oil or palm oil, and very particular preference is given to rapeseed oil methyl ester, sunflower oil methyl ester, palm oil methyl ester and soybean oil methyl ester. Owing to the high demand for biofuels, ever more manufacturers are switching from fatty acid methyl esters to other raw material sources with higher availability. Mention should be made here particularly of used oil, which is used in the form of used oil methyl ester as biodiesel alone or in a blend with other fatty acid methyl esters, for example rapeseed oil methyl ester, sunflower oil methyl ester, palm oil methyl ester and soybean oil methyl ester. The biofuels preferably contain a total of more than 7% by weight, in particular more than 8% by weight and especially more than 9% by weight of palmitic acid methyl ester and stearic acid methyl ester.

The additive can be introduced to the oil to be additized by processes known in the prior art. When more than one additive component or coadditive component is to be used, such components can be introduced into the oil together or separately in any combination.

The inventive additives allow the “modified pour point” of biodiesel to be adjusted to values of −25° C. and in some cases to values of −30° C. The inventive additives are particularly advantageous in problematic oils which have a high proportion of esters of the saturated fatty acids palmitic acid and stearic acid of more than 6% by weight, as present, for example, in fatty acid methyl esters obtained from used oil, sunflower oil, palm oil and soybean oil.

To produce additive packages for specific solutions to problems, the inventive additives may also be used together with one or more oil-soluble coadditives which, even alone, improve the cold flow properties of crude oils, lubricant oils or fuel oils. Examples of such coadditives are polar compounds which bring about paraffin dispersancy (paraffin dispersants) and oil-soluble amphiphiles.

The inventive additives may be used in a mixture with paraffin dispersants. Paraffin dispersants reduce the size of the paraffin crystals and have the effect that the paraffin particles do not settle out but rather remain dispersed in colloidal form with significantly reduced sedimentation tendency. Useful paraffin dispersants have been found to be both low molecular weight and polymeric oil-soluble compounds having ionic or polar groups, for example amine salts and/or amides. Particularly preferred paraffin dispersants comprise reaction products of secondary fatty amines having from 20 to 44 carbon atoms, in particular dicoconut amine, ditallow fat amine, distearylamine and dibehenylamine with carboxylic acids and their derivatives. Particularly useful paraffin dispersants have been found to be those which are obtained by reacting aliphatic or aromatic amines, preferably long-chain aliphatic amines, with aliphatic or aromatic mono-, di-, tri- or tetracarboxylic acids or their anhydrides (cf. U.S. Pat. No. 4,211,534). Equally suitable as paraffin dispersants are amides and ammonium salts of aminoalkylenepolycarboxylic acids, such as nitrilotriacetic acid or ethylenediaminetetraacetic acid, with secondary amines (cf. EP 0 398 101). Other paraffin dispersants are copolymers of maleic anhydride and α,β-unsaturated compounds which may optionally be reacted with primary monoalkylamines and/or aliphatic alcohols (cf. EP 0 154 177), and the reaction products of alkenyl-spiro-bislactones with amines (cf. EP 0 413 279 B1), and, according to EP-A-0 606 055 A2, reaction products of terpolymers based on α,β-unsaturated dicarboxylic anhydrides, α,β-unsaturated compounds and polyoxyalkylene ethers of lower unsaturated alcohols.

The mixing ratio (in parts by weight) of the inventive additives with paraffin dispersants is from 1:10 to 20:1, preferably from 1:1 to 10:1.

The oils treated with the inventive additive may also be used in mineral diesel, and then again be admixed with cold additives or cold-stabilizing additives, such as flow improvers, wax dispersants or performance packages.

The mixing ratio between biofuels and middle distillates may be between 1:99 and 99:1. Particular preference is given to mixing ratios of biofuel:middle distillate=3:97 to 30:70.

Middle distillate refers in particular to those mineral oils which are obtained by distilling crude oil and boil within the range from 120 to 450° C., for example kerosene, jet fuel, diesel and heating oil. Preference is given to using those middle distillates which contain 0.05% by weight of sulfur and less, more preferably less than 350 ppm of sulfur, in particular less than 200 ppm of sulfur and in special cases less than 50 ppm of sulfur. They are generally those middle distillates which have been subjected to refining under hydrogenating conditions, and which therefore contain only small proportions of polyaromatic and polar compounds. They are preferably those middle distillates which have 95% distillation points below 370° C., in particular 350° C. and in special cases below 330° C. Suitable middle distillates are also synthetic fuels, as made available, for example, by the Fischer-Tropsch process.

The additives may be used alone or else together with other additives, for example with other pour point depressants, cold flow improvers or dewaxing aids, with antioxidants, cetane number improvers, dehazers, demulsifiers, detergents, dispersants, defoamers, dyes, corrosion inhibitors, conductivity improvers, sludge inhibitors, odorants and/or additives for lowering the cloud point.

### EXAMPLES

TABLE 1
Characterization of the ethylene copolymers used

| | | | CH₃/100 | Vinyl esters |
|---|---|---|---|---|
| Example | Comonomer(s) | V₁₄₀ | CH₂ | with >C₂ |
| A1 (C) | Ethylene/VAC/vinyl | 110 | 4.2 | 1.5 |
| | neodecanoate | mPas | | |
| A2 | Ethylene/VAC/vinyl | 127 | 3.3 | 8.1 |
| | neodecanoate | mPas | | |
| A3 | Ethylene/VAC/vinyl | 227 | 3.2 | 8.3 |
| | neodecanoate | mPas | | |

VAC = vinyl acetate, vinyl ester content determined by means of pyrolysis and subsequent titration
V₁₄₀ measured on a Haake Reostress 600 viscometer
Degree of branching measured on a ¹H NMR instrument at 400 MHz in CDCl₃ and determined via the integrals of the individual signals.

TABLE 2
Characterization of the comb polymers used

| | | | | Acid number |
|---|---|---|---|---|
| Example | Comonomers | Alcohol/amine | Q | [mg KOH/g] |
| B1 | MA-co-C₁₄/₁₆-α- | C₁₂ amine | 25 | 2 |
| | Olefin | | | |
| | (1.0.5:0.5) | | | |
| B2 | MA-co-C₁₄/₁₆-α- | C₁₄ amine | 25.0 | 57 |
| | Olefin | | | |
| | (1.0.5:0.5) | | | |

TABLE 3
Characterization of the acrylates used

| | |
|---|---|
| C1 | Poly(octadecyl acrylate), K value 32 |
| C2 | Poly(behenyl acrylate), K value 18 |

TABLE 4
Characterization of the test oils

| Oil No.: | CFPP [° C.] | Composition |
|---|---|---|
| E1 | −5 | SME |
| E2 | −5 | SME |
| E3 | −6 | SME |
| E4 | −7 | AME |

SME = soybean oil methyl ester
AME = used oil methyl ester

TABLE 5
Methyl ester distribution of the test oils

| Chains | E1 | E2 | E3 | E4 |
|---|---|---|---|---|
| C16:0 | 10.54 | 10.11 | 10.71 | 1.61 |
| C18:0 | 3.14 | 3.38 | 4.04 | 4.41 |
| C18:1 | 24.02 | 26.68 | 24.50 | 35.99 |
| C18:2 | 52.59 | 49.52 | 51.77 | 40.71 |
| C18:3 | 5.49 | 7.21 | 5.44 | 2.52 |
| C20:1/2/3 | 0.37 | 0.41 | 0.33 | 0.7 |
| C20:0 | 0.19 | 0.39 | 0.43 | 0.5 |
| C22:0 | 0.42 | 0.40 | 0.48 | 0.58 |

TABLE 6
CFPP testing in test oil E1
A:B ratio is 1:5
(A:B):C ratio is (1:5):0.05

| | Comb | Ethylene | | Assessment at | | |
|---|---|---|---|---|---|---|
| Ex. | polymer | copolymer | Polyacrylate | −5° C. | −15° C. | −25° C. |
| 1 (C) | B1 | A1 | — | liquid | solid | solid |
| 2 | B1 | A2 | — | liquid | liquid | liquid |
| 3 | B1 | A3 | — | liquid | liquid | liquid |
| 4 (C) | B2 | A1 | — | liquid | solid | solid |
| 5 | B2 | A2 | C1 | liquid | liquid | liquid |
| 6 | B2 | A3 | — | liquid | liquid | liquid |

TABLE 7
CFPP testing in test oil E2
A:B ratio is 1:5

| | | |
|---|---|---|
| Comb | Ethylene | Assessment at |

| Ex. | polymer | copolymer | −5° C. | −15° C. | −25° C. |
|---|---|---|---|---|---|
| 7 (C) | B1 | A1 | solid | solid | solid |
| 8 | B1 | A2 | liquid | liquid | liquid |
| 9 | B1 | A3 | liquid | liquid | liquid |

TABLE 8
CFPP testing in test oil E3
A:B ratio is 1:5

| | Comb | Ethylene | Assessment at | | |
|---|---|---|---|---|---|
| Ex. | polymer | copolymer | −5° C. | −15° C. | −25° C. |
| 10 (C) | B1 | A1 | liquid | liquid | solid |
| 11 | B1 | A2 | liquid | liquid | liquid |
| 12 | B1 | A3 | liquid | liquid | liquid |

TABLE 9
CFPP testing in test oil E4
A:B ratio is 1:5
(A:B):C ratio is (1:5):0.05

| | Comb | Ethylene | | Assessment at | | |
|---|---|---|---|---|---|---|
| Ex. | polymer | copolymer | Polyacrylate | −5° C. | −15° C. | −25° C. |
| 13 (C) | B1 | A1 | — | liquid | solid | solid |
| 14 | B1 | A2 | C2 | liquid | liquid | liquid |
| 15 | B1 | A3 | — | liquid | liquid | liquid |

1. A fuel oil composition comprising a fuel oil of animal or vegetable origin, in which a total of more than 6% by weight of palmitic acid methyl ester and stearic acid methyl ester are present, and an additive comprising:
A) at least one copolymer which contains 10-20 mol % of structural units of at least one vinyl ester and 80-90 mol % of structural units of ethylene, and
B) at least one comb polymer having structural units formed from
B1) at least one olefin as monomer 1, which bears at least one C₈-C₁₈-alkyl radical on the olefinic double bond, and
B2) at least one ethylenically unsaturated dicarboxylic acid as monomer 2, which bears at least one C₈-C₁₆-alkyl radical bonded via an amide and/or imide group,
in which the parameter Q
$$Q = {\sum }_{i} {w}_{1 i} \cdot {n}_{1 i} + {\sum }_{j} {w}_{2 j} \cdot {n}_{2 j}$$
in which
w₁ is the molar proportion of the individual chain lengths n₁ in the alkyl radicals of monomer 1,
w₂ is the molar proportion of the individual chain lengths n₂ in the alkyl radicals of the amide and/or imide groups of monomer 2,
n₁ are the individual chain lengths in the alkyl radicals of monomer 1,
n₂ are the individual chain lengths in the alkyl radicals of the amide and/or imide groups of monomer 2,
i is the serial variable for the chain lengths in the alkyl radicals of monomer 1, and
j is the serial variable for the chain lengths in the alkyl radicals of the amide and/or imide groups of monomer 2,
assumes values of from 23 to 27.

2. The fuel oil as claimed in claim 1, in which Q assumes values of from 24 to 26.

3. The fuel oil as claimed in claim 1, in which constituent A) comprises from 13 to 18 mol % of the at least one vinyl ester.

4. The fuel oil of claim 1, in which constituent A) comprises from 0.5 to 10 mol % of an olefin having from 3 to 10 carbon atoms.

5. The fuel oil of claim 1, in which constituent A) has a degree of branching of less than 6 CH₃/100CH₂ groups, determined by means of ¹H NMR spectroscopy.

6. The fuel oil of claim 1, wherein the at least one olefin of B1) is an α-olefin.

7. The fuel oil of claim 1, in which B1) and B2) are present in the copolymer B) in a molar ratio between 1.5:1 and 1:1.5.

8. The fuel oil of claim 1, in which the at least one comb polymer, as well as monomer 1 and monomer 2, further comprise up to 20 mol % of a further comonomer other than monomer 1 or monomer 2, selected from the group consisting of an olefin having 2 to 50 carbon atoms, a allylpolyglycol ether, a C₁-C₃₀-alkyl (meth)acrylate, a vinylaromatic ether or a C₁-C₂₀-alkyl vinyl ether, and a polyisobutene having a molecular weight of up to 5000 g/mol.

9. The fuel oil of claim 1, in which constituent A) has a melt viscosity V₁₄₀ of from 80 to 300 mPas.

10. The fuel oil of claim 1, in which constituent A) has a molecular weight of from 3000 to 20 000 g/mol.

11. The fuel oil of claim 1, in which constituent B) has a molecular weight of from 1200 to 200 000 g/mol.

12. A method for improving pour point properties under cold conditions of a fuel oil of animal or vegetable origin, said method comprising adding to said fuel oil under said cold conditions a total of more than 6% by weight of palmitic acid methyl ester and stearic acid methyl ester.

13. A method for determining pour point of a sample of the fuel to be examined, said method comprising adding to the sample a flow improver and introducing the sample into a colorless transparent sample vessel, heating said sample to a test temperature and storing said sample at the test temperature for at least 24 hours, and assessing the sample for a homogeneous fluid consistency.
